(19) United States
(12) Patent Application Publication
(10) Pub. No.: US 2007/0271999 A1
(43) Pub. Date: Nov. 29, 2007

(54) Low current depletion control device

(76) Inventors: Chen-Wei Lin, Nantou City (TW); Meng-Cheih Lu, Tanzih Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/433,443

(22) Filed: May 15, 2006

(51) Int. Cl. G01M 3/08

(52) U.S. Cl. 73/48

(57) ABSTRACT

The present invention relates to a low current depletion control device that allows substituting MOS transistors for bipolar transistors and comprises a battery, a switch, a control switch, a self-holding switch, a controller, a driving unit, and a drain switch. The battery connects with the switch that connects with the control switch. The switch controls the control switch. The battery and the control switch connect with the self-holding switch that further connects with the controller. The control switch controls the self-holding switch. The controller connects with the driving unit that further connects with the drain switch. The controller controls the driving unit, and the driving unit controls the drain switch that turn off the control switch.

### BACKGROUND OF THE INVENTION

1. Field of the Invention

The present invention relates to a low current depletion control device, and more particularly to a control device that initially performs controlling based on a switch and provides a power source based on a low voltage battery.

2. Description of the Prior Art

A tire pressure detection is very important for safety while vehicles are moving. The incorrect pressure of a vehicle's tire is the main reason behind tires being punctured. If the tires are worn, torn or have changed shape due to external forces or weather variations the tire pressure is affected. If drivers inflate the tires improperly or do not often maintain and check the tire pressure, the tires will be punctured more easily. Moreover, if the pressure of the tires is maintained normally, the oil the vehicle uses will decrease, and vehicle safety while will be increased.

Referring to FIG. 1, an electrical diagram of the previous tire pressure detector is shown. The tire pressure detector 1 detects the speed of a motor vehicle via a centrifugal switch SW1. If the speed of the motor vehicle is larger than the preset value, the centrifugal switch SW1 will close, and the current detection switch circuit combined by the transistors Q12 and Q11 will operate for further forming a self-holding circuit 12. If the speed of the motor vehicle is normal, the battery 10 will support the controller 14 and charge the charging capacitance C13 through the self-holding circuit 12 and the forward diode D11. The controller 12 can detect the tire pressure, the temperature, the acceleration, the battery voltage and so on. If the speed of the motor vehicle is slow enough for further opening the centrifugal switch SW1, the controller 14 will continuously operate based on the self-holding circuit 12. If the speed of the motor vehicle is less than another preset value, the controller 14 will turn off the transistors Q12 and Q11 in sequence based on a low potential for further stopping operation of the self-holding circuit 12. Then, the battery 10 will stop supporting the controller 14, and the charging capacitance C13 provides an operation voltage VDD to the controller 14.

When the battery 10 supports the controller 14, there is a potential difference between the two ends of the forward diode D11. The potential difference affects what the battery 10 provides to the controller 14 and decreases the life of the battery 10. Moreover, the transistor Q12 and Q11 are bipolar transistors. If a bipolar transistor is open, the open resistance will be kilo-ohm, and the current depletion will be very large. Similarly, the consumption current while the bipolar transistor is ON will be very large. Thus, the bipolar transistor will rapidly decrease the life of the battery 10.

### SUMMARY OF THE INVENTION

The first object of the present invention is that the controller directly connects with the battery through an MOS switch including MOS transistors.

Another object of the present invention is that the output side of the controller adds a driving unit in order to eliminate self-holding actions of the circuit.

In order to reach the above objects, the low current depletion control device of the present invention includes a battery, a switch, a control switch, a self-holding switch, a controller, a driving unit, and a drain switch. The battery connects with the switch that connects with the control switch. The switch controls the control switch. The battery and the control switch connect with the self-holding switch that connects with the controller. The control switch controls the self-holding switch. The controller connects with the driving unit that connects with the drain switch. The controller controls the driving unit, and the driving unit controls the drain switch that cuts off the control switch.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is a electrical diagram of the previous tire pressure detector; and

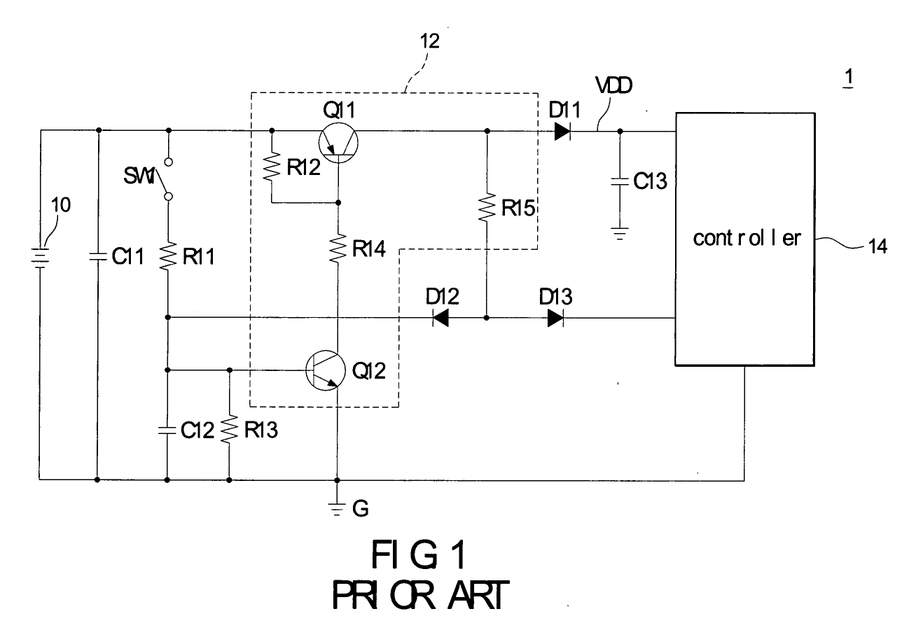

FIG. 2 is a electrical diagram of the low current depletion control device of the present invention.

The drawings will be described further in connection with the following detailed description of the present invention.

### DETAILED DESCRIPTION OF THE PREFERRED EMBODIMENTS

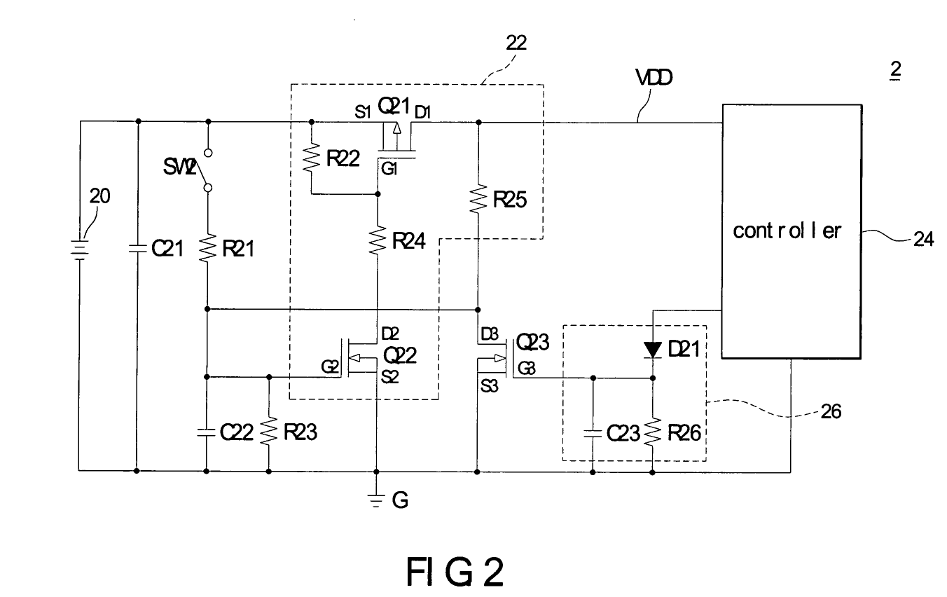

Referring to FIG. 2, an electrical diagram of the low current depletion control device of the present invention is shown. The low current depletion control device 2 includes a battery 20, a switch SW2, a control switch Q22, a self-holding switch Q21, a controller 24, a driving unit 26, and a drain switch Q23, wherein the switch SW2 can be a centrifugal switch and so on. The battery 20 connects with the switch SW2 which further connects with the control switch Q22. The switch SW2 controls the control switch Q22. The self-holding switch Q21 connects with the battery 20, the control switch Q22, and the controller 24. The control switch Q22 controls the self-holding switch Q21. The controller 24 connects with the driving unit 26 which further connects with the drain switch Q23. The controller 24 controls the driving unit 26 and can support a wireless tire pressure detector. The driving unit 26 controls the drain switch Q23 that cuts off the control switch Q22.

In addition, the control switch Q22 is an NMOS and includes a gate G2, a source S2, and a drain D2. The gate G2 connects with the switch SW2, and the source S2 connects with the ground G. The self-holding switch Q21 is a PMOS and includes a gate G1, a source S1, and drain D1. The gate G1 connects with the drain D2, the source S1 connects with the battery 20, and the drain D1 connects with the controller 24. The drain switch Q23 is an NMOS and includes a gate G3, a source S3, and drain D3. The gate G3 connects with the driving unit 26, the drain D3 connects with the gate G2, and the source S3 connects with the ground G. Furthermore, the driving unit 26 includes a forward diode D21, a charging capacitance C23, and a discharging resistance R26. The positive pole of the forward diode D21 connects with the controller 24, and the negative pole of the forward diode D21 connects with the charging capacitance C23 that connects with the discharging resistance R26.

For example, the low current depletion control device of the present invention can connect to many kinds of loads, such as a wireless tire pressure detector. If the driving speed is faster than a preset driving speed, the switch SW2 closes, and the control switch Q22 and the self-holding switch Q21 turns on, respectively. The control switch Q22, the self-holding switch Q21 and the resistance 25 combine to form a self-holding circuit 22. Even if the switch SW2 opens, the control switch Q22 and the self-holding switch Q21 will still turn on. If the driving speed is normal, the battery 20 provides an operation voltage VDD to the controller 24 through the self-holding switch Q21. Furthermore, the controller 24 can detect the tire pressure, the temperature, the acceleration, the battery voltage and so on.

If the driving speed decreases, the switch SW2 opens, and the controller 24 will continue to operate. If the driving speed is slower than a set value, the controller 24 increases the output voltage to control the driving unit 26. The driving unit 26 further drives the drain switch Q23 to turn on, and the drain switch Q23 respectively cuts off the control switch Q22 and the self-holding switch Q21 in sequence to stop the operation of the self-holding circuit 22. Next, the battery 20 stops providing the operation voltage VDD to the controller 24. When stopping the operation of the self-holding circuit 22, the control switch Q22 and the self-holding switch Q21 will respectively cut off. The controller 24 will output the high voltage to charge the capacitance C23 in the driving unit 26 through the forward diode D21, and the capacitance C23 will further support the power source of the drain switch Q23. Furthermore, the charge time that the controller 24 spends charging the capacitance C23 relates to a RC time constant produced by the resistance R26 and the capacitance C23. Thus, the drain switch Q23 will turn ON for further ensuring that the control switch Q22 and the self-holding switch Q21 won't be latched or turned ON.

An advantage of the present invention is the decreasing of the operation current and the current leakage based on MOS transistors. The previous control device was designed to switch via bipolar transistors. Because the bias resistances of the bipolar transistors are about K ohm, the current depletion that occurs while the bipolar transistors are ON is more than 10 mA, and the current leakage that occurs while the bipolar transistors are OFF is more than 10 uA. However, because the bias resistances of the MOS transistors are about M ohm, the current depletion that occurs while the MOS transistors are ON is more than 10 uA, and the current leakage that occurs while the MOS transistors are OFF is more than 10 nA.

Another advantage of the present invention is the increasing of the operation voltage VDD based on the drain switch Q23, the capacitance C23, the resistance R26, and the diode D21. The previous control device stops one of the discharging paths of the capacitance C13 via the diode D11, so that the operation voltage VDD of the controller 14 is 0.4˜0.9 V less than the voltage of the battery 10 under −40˜125° C. This decreases the operating life of products. However, the operation voltage VDD that the present invention provides to the controller 24 is similar to the voltage of the battery 20 under −40˜125° C. This doesn't decrease the operating life of the products.

Another advantage of the present invention is the controlling of the discharging time of the capacitances for further ensuring that the self-holding circuit is turned OFF based on any load and any temperature. The previous control device discharges from the capacitance C13 into the controller 14, and the discharging time is controlled by the load of the controller 14. Designers cannot control the discharging time. If the load of the controller 14 is too large, the self-holding circuit will be not turn OFF or maintain the voltage utilizing a high power capacitance (which is not shown). However, the present invention discharges from the capacitance C23 into the resistance R26 and controls the discharging time based on the product of the capacitance C23 and the resistance R26. Thus, designers can control the discharging time based on the product of the capacitance C23 and the resistance R26 without the load and the high power capacitance.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A low current depletion control device, comprising:
a battery;
a switch for connecting with the battery;
a control switch for connecting with the switch, wherein the switch controls the control switch;
a self-holding switch for connecting with the battery and the control switch, wherein the control switch controls the self-holding switch;
a controller for connecting with the self-holding switch;
a driving unit for connecting with the controller, wherein the controller controls the driving unit; and
a drain switch for connecting with the driving unit and the control switch, wherein the drain switch stops the control switch, and the driving unit controls the drain switch.

2. The low current depletion control device as in claim 1, wherein the control switch is an MOS transistor, a gate of the control switch connects with the switch, and a source of the control switch connects to a ground.

3. The low current depletion control device as in claim 2, wherein the control switch is an NMOS transistor.

4. The low current depletion control device as in claim 1, wherein the self-holding switch is an MOS transistor, a gate of the self-holding switch connects with a drain of the control switch, and the self-holding switch connects with the battery, and a drain of the self-holding switch connects with the controller.

5. The low current depletion control device as in claim 4, wherein the self-holding switch is a PMOS transistor.

6. The low current depletion control device as in claim 1, wherein the drain switch is an MOS transistor, a gate of the drain switch connects with the driving unit, a drain of the drain switch connects with a gate of the control switch, and a source of the drain switch connects with the ground.

7. The low current depletion control device as in claim 6, wherein the drain switch is an NMOS transistor.

8. The low current depletion control device as in claim 1, wherein the driving unit further comprises:
a forward diode, wherein the positive pole of the forward diode connects with the controller;
a charging capacitance for connecting with the negative pole of the forward diode; and
a discharging capacitance for connecting with the charging capacitance.

9. The low current depletion control device as in claim 1, wherein the controller is a wireless tire pressure detector.

10. The low current depletion control device as in claim 9, wherein the wireless tire pressure detector detects a tire's pressure, temperature, acceleration, and the voltage of a battery.

11. The low current depletion control device as in claim 1, wherein the switch is a centrifugal switch.
